(19) United States
(12) Patent Application Publication
(10) Pub. No.: US 2010/0247699 A1
(43) Pub. Date: Sep. 30, 2010

(54) IMPRINTING MOLD WITH GROOVE FOR EXCESS MATERIAL

(75) Inventor: TAI-CHERNG YU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng,Taipei Hsien (TW)

(21) Appl. No.: 12/616,198

(22) Filed: Nov. 11, 2009

(30) Foreign Application Priority Data
Mar. 30, 2009 (CN) 200910301199.0

(51) Int. Cl. B29C 43/58

(52) U.S. Cl. 425/150

(57) ABSTRACT

An exemplary imprinting mold includes a molding surface, a microstructure, and grooves. The microstructure is formed on the molding surface and configured for molding an optical component. The grooves are defined in the molding surface and extend from the microstructure.

### BACKGROUND

1. Technical Field

The present disclosure relates to imprinting technology, and particularly, to an imprinting mold for making an optical component such as a lens.

2. Description of Related Art

Imprinting technology is a simple process with low cost, high throughput and high resolution. Imprinting technology is widely used for making optical components, such as lenses in a wafer lens package (WLP) process.

In a typical imprinting process, a blob of molding material is applied to a silicon substrate, and then an imprinting mold is pressed on the molding material on the substrate. However, if the amount of the blob of molding material applied is larger than a desired amount, the imprinting mold cannot be pressed completely onto the substrate. This may result in a significant difference between the optical component desired and the optical component actually obtained.

Therefore, an imprinting mold which can overcome the above mentioned problems is desired.

### BRIEF DESCRIPTION OF THE DRAWINGS

In the drawings, all the views are schematic.

FIG. 1 is a plan view of an imprinting mold, according to a first exemplary embodiment.

FIG. 2 is a plan view of an imprinting mold, according to a second exemplary embodiment.

FIG. 3 is a plan view of an imprinting mold, according to a third exemplary embodiment.

FIG. 4 is a plan view of an imprinting mold, according to a fourth exemplary embodiment.

FIGS. 5 to 6 are side cross-sectional views of successive stages in a method for making a lens on a silicon substrate, using the imprinting mold of FIG. 1.

### DETAILED DESCRIPTION

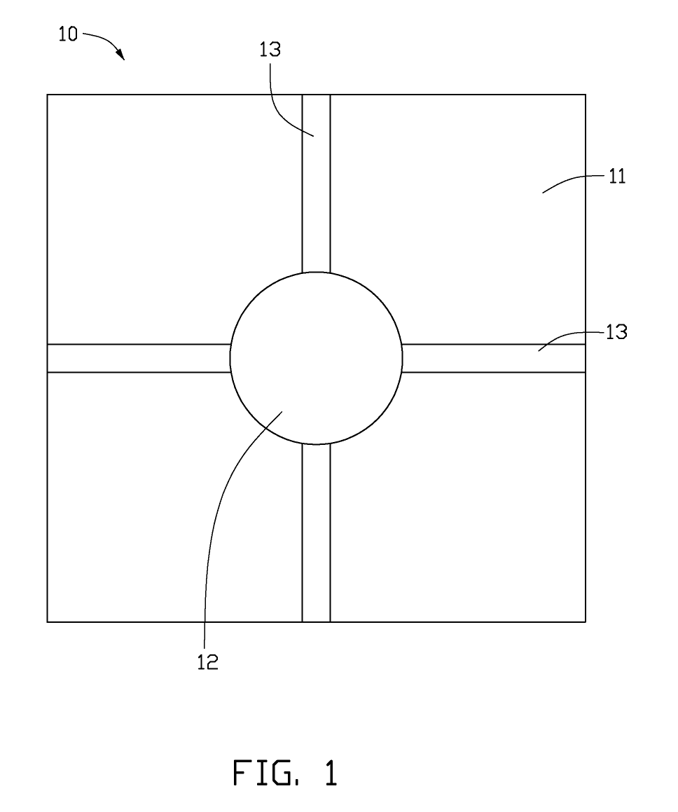

Referring to FIG. 1, an imprinting mold 10, according to a first exemplary embodiment, is shown. The imprinting mold 10 can be used for making any of a variety of optical components, such as a lens. The imprinting mold 10 may be made from a material selected from the group consisting of silicon, tungsten carbide, carborundum, silicon nitride, titanium carbide, and tungsten-cobalt alloy carbide.

The imprinting mold 10 includes a molding surface 11, and a microstructure 12 formed at the molding surface 11. The molding surface 11 is substantially rectangular. The microstructure 12 is configured for molding an optical component. In this embodiment, the microstructure 12 comprises a recess defined in the molding surface 11, with a surface of the microstructure 12 being aspheric. It will be understood that in alternative embodiments, the surface of the microstructure 12 can for example be spherical instead.

Four grooves 13 are defined in the molding surface 11, with all the grooves 13 being in communication with the microstructure 12. Each of the four grooves 13 is elongate. The four grooves 13 are radially arranged around the microstructure 12, and are evenly spaced apart from each other. Each groove 13 spans from the microstructure 12 to a corresponding edge of the molding surface 11. It can be understood that the number of grooves 13 may be other than four.

One advantage of the grooves 13 is that, during an imprinting process, air trapped in the microstructure 12 can be released through the grooves 13. This helps avoid air bubbles from forming in the optical component made by the imprinting mold 10. Another advantage of the grooves 13 is that they provide space for excess molding material of the optical component to escape to. This means the optical component made by the imprinting mold 10 can be made accurately according to its design specifications.

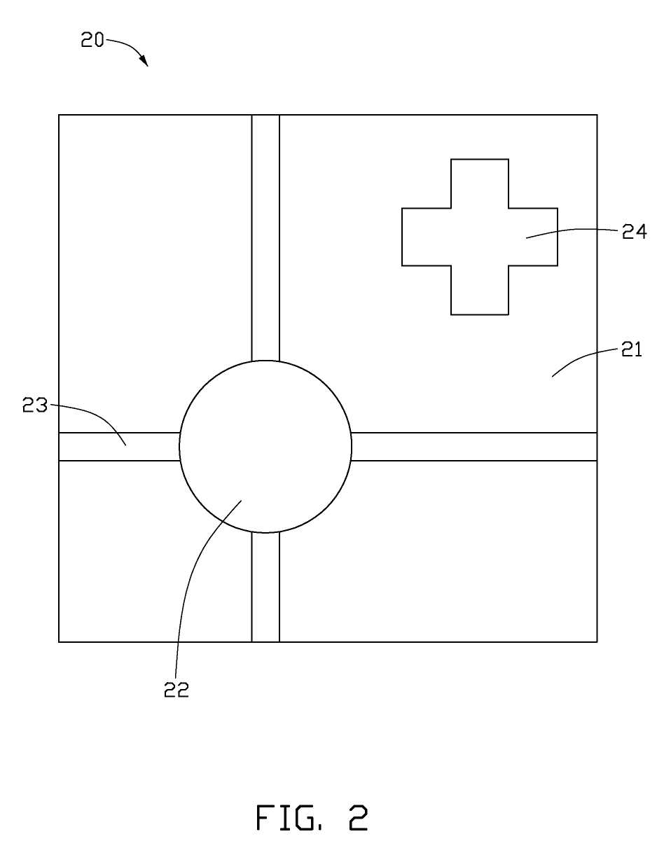

Referring to FIG. 2, an imprinting mold 20, according to a second exemplary embodiment, is shown. The difference between the imprinting mold 20 and the imprinting mold 10 of the first exemplary embodiment is that the imprinting mold 20 further includes an alignment mark 24 formed on the molding surface 21. The alignment mark 24 is located separately from the microstructure 22 and the grooves 23.

In this embodiment, the alignment mark 24 comprises a cross-shaped recess defined in the molding surface 21.

The microstructure 22 is positioned at a lower left portion of the molding surface 21, and the alignment mark 24 is positioned at an upper right portion of the molding surface 21. It can be understood that in alternative embodiments, the microstructure 22 and the alignment mark 24 can be positioned at other locations of the molding surface 21.

When using the imprinting mold 20 to imprint a molding material applied on a substrate, a complementary alignment mark is formed on the substrate by the alignment mark 24. The complementary alignment mark can be used for a second-time imprinting process in the case of a dual-surface imprinting process or a stacking imprinting process. Thereby, decentration of lenses formed by such imprinting process can be minimized or even avoided altogether.

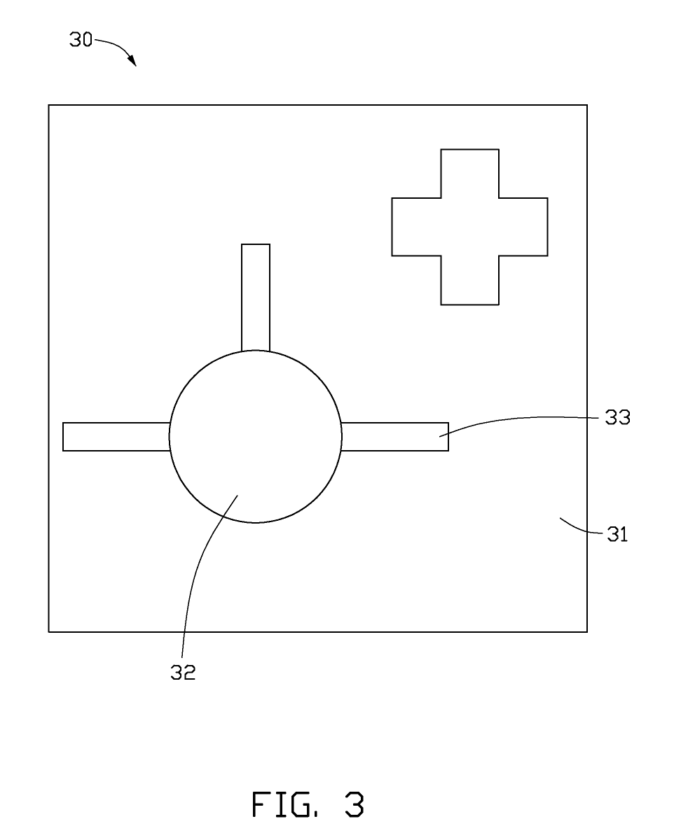

Referring to FIG. 3, an imprinting mold 30, according to a third exemplary embodiment, is shown. The difference between the imprinting mold 30 and the imprinting mold 20 of the second exemplary embodiment is that the grooves 33 are different from the grooves 23.

In particular, three grooves 33 are defined in the molding surface 31, with all the grooves 33 being in communication with the microstructure 32. Each of the three grooves 33 is elongate, and an end of each groove 33 distant from the microstructure 32 is closed (blind). That is, none of the grooves 33 span as far as an edge of the molding surface 31.

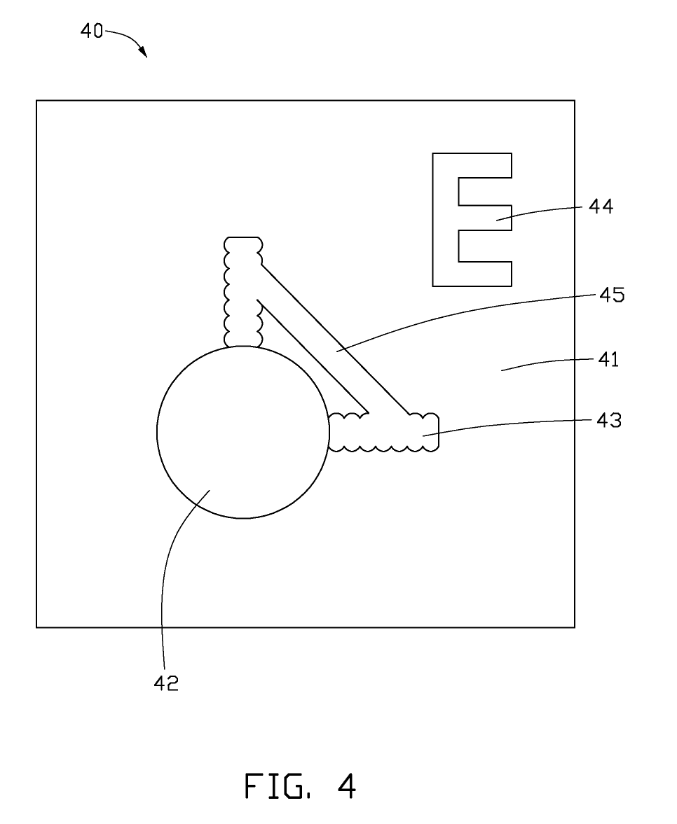

Referring to FIG. 4, an imprinting mold 40, according to a fourth exemplary embodiment, is shown. The imprinting mold 40 includes a molding surface 41, a microstructure 42, and an alignment mark 44 formed on the molding surface 41. The microstructure 42 comprises a recess defined in the molding surface 41 in this exemplary embodiment.

Two grooves 43 each having opposite wavelike walls are defined in the molding surface 41, with both the grooves 43 being in communication with the microstructure 42. A connecting groove 45 is further defined in the molding surface 41. The connecting groove 45 is in communication with end portions of the two grooves 43 distant from the microstructure 42. The connecting groove 45 is configured for receiving excess molding material from the two grooves 43. The alignment mark 44 is E-shaped in this embodiment. It can be understood that in alternative embodiments, the alignment mark 44 may for example be I-shaped, F-shaped, or T-shaped.

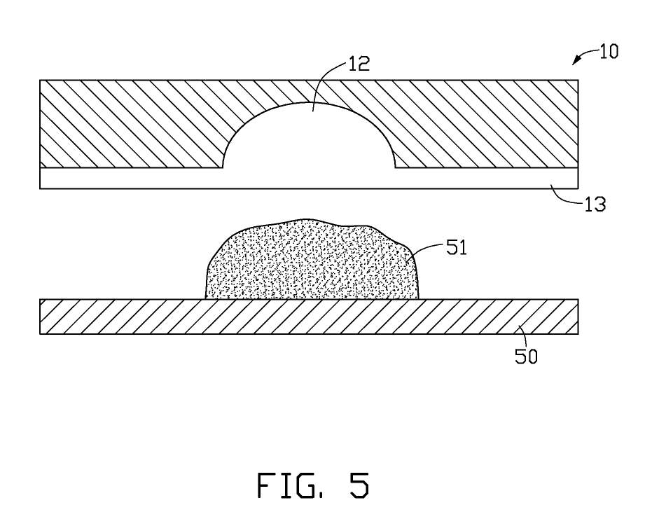

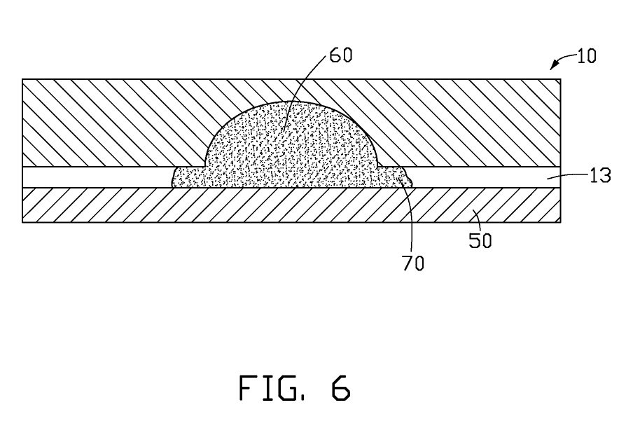

Referring to FIGS. 5 and 6, the imprinting mold 10 can for example be used to make a lens on a silicon substrate 50. In this process, a blob of molding material 51 is applied to the substrate 50. Then the imprinting mold 10 is pressed on the molding material 51 on the substrate 50, and pressed portions of the molding material 51 are solidified with ultraviolet (UV) light to form a lens 60. The grooves 13 can receive excess molding material 70. Therefore, the lens 60 can be accurately formed according to its design specifications.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An imprinting mold, comprising:
a molding surface;
a microstructure formed at the molding surface and configured for molding an optical component; and
at least one groove defined in the molding surface and extending from the microstructure.

2. The imprinting mold of claim 1, wherein the at least one groove spans from the microstructure to a corresponding edge of the molding surface.

3. The imprinting mold of claim 1, further comprising an alignment mark arranged on the molding surface, the alignment mark located separately from the microstructure and the at least one groove.

4. The imprinting mold of claim 3, wherein a shape of the alignment mark is selected from the group consisting of cross-shaped, E-shaped, I-shaped, F-shaped, and T-shaped.

5. The imprinting mold of claim 3, wherein the alignment mark comprises a recess defined in the molding surface.

6. The imprinting mold of claim 1, wherein the microstructure comprises a recess defined in the molding surface.

7. The imprinting mold of claim 6, wherein the at least one groove is in communication with the microstructure.

8. The imprinting mold of claim 1, wherein the at least one groove is elongate.

9. An imprinting mold, comprising:
a molding surface;
a recess defined in the molding surface and configured for molding an optical component; and
at least one groove defined in the molding surface and being in communication with the recess.

10. The imprinting mold of claim 9, wherein a surface of the recess is aspheric.

11. The imprinting mold of claim 9, further comprising an alignment mark arranged on the molding surface, the alignment mark located separately from the recess and the at least one groove.

12. The imprinting mold of claim 11, wherein the alignment mark comprises a recess defined in the molding surface.
